(19) United States
(12) Patent Application Publication
(10) Pub. No.: US 2026/0153175 A1
(43) Pub. Date: Jun. 4, 2026

(54) ANTI-ROTATION DEVICE FOR A QUICK CONNECTOR, NOZZLE ASSEMBLY, QUICK CONNECTOR COMPRISING AN ANTI-ROTATION DEVICE, AND METHOD FOR MOUNTING SAME

(71) Applicant: Webasto SE, Stockdorf (DE)

(72) Inventors: Rupert Mitterer, Stockdorf (DE); Peter Neidenberger, Stockdorf (DE)

(21) Appl. No.: 19/118,862

(22) PCT Filed: Nov. 24, 2023
(86) PCT No.: PCT/EP2023/082992

§ 371 Date: Apr. 7, 2025

(30) Foreign Application Priority Data
Nov. 25, 2022 (DE) 102022212634.3

(51) Int. Cl. F16L 15/08; F16L 37/088; F16L 37/098; F16L 37/14; F16L 37/42

(52) U.S. Cl. CPC F16L 37/0885; F16L 37/12

(57) ABSTRACT

An anti-rotation lock for a connecting piece of a quick connector which is configured to receive a coupling; comprises a main body having at least one first anti-rotation lock element which is configured and dimensioned to form a projection on the connecting piece, the projection extending in an axial direction with respect to the connecting piece and being configured to interact with a matching recess in the coupling, in order to prevent a rotation of the coupling relative to the connecting piece in a coupled state of the quick connector.

### CROSS-REFERENCE TO RELATED APPLICATIONS

This application is a 35 U.S.C. § 371 National Stage Entry of International Application No. PCT/EP2023/082992 filed Nov. 24, 2023, which claims the priority benefit of German Patent Application Serial Number DE 10 2022 212 634.3 filed Nov. 25, 2022, all of which are incorporated herein by reference in their entirety for all purposes.

### TECHNICAL FIELD

Various aspects of the invention relate to an anti-rotation lock for a plug connector, in particular for a quick connector or a quick coupling, as are configured, for example, in motor vehicles for receiving or dispensing media or fluids, e.g. on heaters, cooling devices or also charge air ducts, etc. Furthermore, aspects relate to a corresponding socket device with an anti-rotation lock, a quick connector comprising a coupling and a socket device as well as a method for assembling an anti-rotation lock on such a socket device.

### TECHNICAL BACKGROUND

It is known and customary to employ plug connectors for connecting media-carrying lines in the field of cooling-water and heating lines as well as in a case of usage in charge air systems, in particular in motor vehicles. These are often hoses which are to be connected to corresponding devices, so that in this case reference is made to hose couplings or quick couplings. They enable a quick and very reliable connection and exchange of assemblies and devices. The respective designs depend on the medium conveyed in the hose as well as on the pressure conditions present in the hose. In order to simplify the handleability for the users and in order to create a broad platform for providers, unifying standards have been provided, such as, for instance, the Henn- or VDA systems for quick couplings.

In this connection, it should be pointed out that in practice, under “quick coupling”, in some cases the coupling is considered to be the one part of the plug connector, in some other cases, however, the overall combination of a coupling and a plug-in part or socket device fitting thereto is considered as “quick coupling”. In this application, the term “quick connector” is used for the connector comprising both parts (the coupling and the plug-in part or socket) if the coupling is a quick coupling.

In order to establish a fluid or media connection, a quick coupling forms a connection between a fluid-conducting device (heater, cooler, etc.), which is usually fixedly installed in the motor vehicle, and a generally more flexible, fluid-or media-conducting line, such as, for instance, a hose, which in turn can establish a connection to a further device, to accomplish a potential circulation with respect to the fluid or medium. For this purpose, the quick coupling as an independent component is first connected to the fluid-or media-conducting line (e.g., the hose), and then connected to the respective device in the motor vehicle, by plugging it onto a socket device, which matches the coupling as a plug-in part, and is thereby locked or latched. Consequently, the medium or the fluid can be conducted from the device via the fluid- or media-conducting line to another component of the motor vehicle, or vice versa.

Due to the installation space, quick couplings can be designed as angle connectors, so that the respectively connected line (hose) extends at an angle of, for example, 90° relative to the respective socket of the connector. In this case, it may be desirable for the fluid- or media-conducting line or the hose to extend, for example, in the direction of that vehicle component to which the fluid or medium is to be supplied or from which it is to be supplied to the device under consideration, or for it to extend in a specific direction, in order to avoid an obstacle in the installation space.

Now, in order to allow for a reliable determination of the orientation of the quick coupling relative to the socket on the device and to prevent a potential misorientation during assembly or an unintended rotation during the operation of the motor vehicle, an anti-rotation lock can be provided to the device with regard to the quick coupling and the fitting socket or plug-in part.

Such an anti-rotation lock is, for example, in the case of VDA quick connectors, regularly shaped integrally as a projecting part in a respective socket or is formed as a cast part, a sheet-metal bent part, or a lathed-and-milled part directly integrally with the socket. During the production of the connector, the projecting part engages in a matching groove formed in the quick coupling, so that the latter can no longer be rotated. Thus, after the installation of a socket on the respective fluid-conducting device, the anti-rotation lock is located in a fixed, invariable orientation (relative to the device) in a circumferential direction of the socket, which allows only a single assembly position of a quick connector.

Document EP 1 697 674 B1 discloses, for example, a plug connector for media lines, comprising a tubular plug-in part and a housing part with a plug-in receptacle for receiving a media-tight insertion of the plug-in part. Means for securing the inserted plug-in part against rotation about the plug-in axis are provided therein, which are considered to be desirable, in particular for angled connectors. These means are designed as a section of the plug-in part engaging over the housing of the plug-in receptacle and having a hexagonal or multi-toothed engagement, i.e. are formed integrally with the plug-in part.

Document DE 10 2016 206 622 A1 similarly discloses an anti-rotation lock, which appears to be formed as a projecting component on a fluid interface of a quick coupling.

Document EP 3 591 277 B1 discloses a quick coupling for producing a separable connection in a fluid line of a motor vehicle. The quick coupling has a coupling body. A holder extends around the head part of the coupling body and the holder is designed as an annular body, which secures and retains a tubular plug-in part as a counterpart in the coupling body. The plug-in part has a radial compression, which, during insertion, initially radially expands a movable securing part in cooperation with the holder, but then allows it to snap back. Due to its position, the securing part indicates a reliably closed connection towards the outside. Due to the mentioned cooperation, an anti-rotation lock of the securing part with respect to the holder is established. However, an anti-rotation lock of the quick coupling with respect to the plug-in part is not apparent.

However, some disadvantages result in the described, anti-rotation locks which are shaped or formed integrally with a socket. The dependence of the installation position of the devices in the motor vehicle from the distinct type and manufacturer requires a realization of different orientations of the anti-rotation lock in a circumferential direction. This may lead to a large number of variants on the device or the component, possibly in a very early production step, in which the device is to be provided with the plug-in part or socket. As a result, a large number of variants also occurs successively in the subsequent production steps, as a result of which the time and cost expenditure is increased, especially since a variant formation may also occur in the production devices itself and further expenses relating to the variant control.

Furthermore, an orientation of the anti-rotation lock in the circumferential direction and thus the orientation of the plugged-on coupling with hose on the individual device is fixed by the quick connector due to being integrally formed or shaped and can no longer be easily changed for applications with alternative orientation requirements.

Furthermore, anti-rotation locks may also be present in the standard products in applications in which they are not required at all. Overall, the current practice thus results in little flexibility in the selection and determination of an orientation of an anti-rotation lock in the circumferential direction.

Consequently, there is a need for saving costs and for a reduction of the expenditure for the provision of an anti-rotation lock with regard to quick connectors.

### SUMMARY OF THE INVENTION

The corresponding object may be achieved by aspects of the invention which are specified, for example, in the appended claims, and according to which the anti-rotation lock is designed as an independent component which is separate from the connecting piece and which is advantageously mounted only at a comparatively late point in time of the production progress or even after the completion of a device or component having the connecting piece attached thereto.

Some of such aspects initially start from an anti-rotation lock for a connecting piece or plug-in part of a quick connector which is configured for receiving a coupling. This may be a connecting piece which is fixed on a device such as a heater, a cooler, etc. of a motor vehicle and via which a fluid (or medium) which is to be prepared or is to be prepared in the device is dispensed into the line to be coupled or is drawn therefrom, respectively. This anti-rotation lock comprises a main body having at least one first anti-rotation lock element which is configured and dimensioned to form a projection on the connecting piece, the projection extending in an axial direction with respect to the connecting piece and being configured to interact with a matching recess in the coupling (quick coupling). Preferably, the anti-rotation lock element should be able to prevent a rotation of the coupling relative to the connecting piece in a coupled state of the quick connector when it is brought into position on the connecting piece. As described above, according to aspects of the invention, the main body having the at least one first anti-rotation lock element is formed as a component which is separate from the connecting piece.

The separate design enables the attachment to be carried out at any desired point in time after the provision of the connecting piece. The connecting piece itself may be designed in a neutral manner, i.e. without an anti-rotation lock. If the quick coupling forms the matching counterpart for the anti-rotation lock in the form of a groove, this connecting piece may then also serve as a basis for freely rotatable connectors. Furthermore, a connecting piece which is free from integrally formed or shaped projections may avoid a further variant formation, because there is only the one basic shape which is used through all production steps. This results in considerable time and cost savings in the design of the production chain, which justifies possible, but in any case only slight, additional costs owing to the production of an additional separate component.

In an advantageous development, the main body of the anti-rotation lock has a ring shape with a central axis. The central axis may preferably coincide with a central axis of the connecting piece in a state of the anti-rotation lock mounted on the connecting piece. In practice, this ring may simply be slipped over the connecting piece during the assembly and thereby plugged on. The ring may then be placed and fixed at a base of the connecting piece, whereby the at least one first anti-rotation lock element is brought into the intended position, and whereby an orientation of the anti-rotation lock and thus of a connected quick coupling in is defined in a circumferential direction.

According to an embodiment, a second anti-rotation lock element is provided next to the first anti-rotation lock element. Both anti-rotation lock elements may be located opposite each other at the ring-shaped main body and extend from the main body in a direction parallel to the central axis. The expediently ring-shaped structure of the main body ensures a safe and reliable seat and stability of the orientation.

In compliance with the VDA quick connector standard, the two anti-rotation lock elements may preferably have a mutually different length in an axial direction, width in a circumferential direction and/or depth in a radial direction. As a result, in cooperation with correspondingly dimensioned matching recesses in the quick coupling, a possible alternative coupling that is rotated by 180° can be excluded, so that the definition of the hose orientation after assembly of the component of the anti-rotation lock is unambiguous and errors are avoided.

In order to enable a safe position, for example, at the base of the connecting piece, according to an embodiment, at least one latching element may be provided. This at least one latching element may, for example, be attached to the ring-shaped main body. Furthermore, the at least one latching element may be configured to engage in a groove which may regularly be provided at the base of the connecting piece, in order to fix the anti-rotation lock in a defined position close to a base component of the respective device with respect to an axial direction. According to further embodiments, the main body thereby rests on the base component.

A particularly interesting aspect of the anti-rotation lock provides for setting up an index section thereon—as an independent section or as a shaping of the main body itself. Hereby, a subdivision of a workpiece into precise angles or rotation intervals (pitches) for a machining process is referred to as indexing (see, for example, Machinery's Handbook, 25th edition, section Milling machines). A corresponding index section consequently includes a subdivision, in a circumferential direction, into rotation intervals which are separated by discrete subdivision points. In the present case, the generalized principle explicitly includes the case in which only one subdivision point is present, i.e. the rotation interval is 360°. According to embodiments to be described below, fixing means are provided at this or these subdivision point(s) of the index section, which fixing means cooperate with a counterpart (or a plurality of counterparts) on the base component of the device, but not of the connecting piece. These counterparts likewise form an index section on the device side. Consequently, this aspect provides that the index section of the anti-rotation lock cooperates in a form-fitting manner with a corresponding index section on the base component—preferably in a surrounding area of the connecting piece. As a result, the anti-rotation lock is now also fixed in a circumferential direction in at least one defined position, ideally in a plurality of selectable positions corresponding to the number of subdivision points.

One embodiment provides that the index section of the anti-rotation lock and/or the index section on the base component of the device have a plurality of defined subdivision points in a circumferential direction. The advantage is the improved selection of the orientation possibilities during the subsequent assembly.

Another embodiment provides that the index section is formed by a projection which extends outward from the ring-shaped main body in a radial direction and by a pin which extends from the projection in a substantially axial direction and is configured to latch into a recess in a surrounding area of the connecting piece on the device. Conversely, the pin may also be configured on the base component of the device, while the projection has a recess into which the pin latches or engages.

A further embodiment provides that the index section is formed by a projection which extends outward from the ring-shaped main body in a radial direction and is formed as a flat ring, and is formed by a number of recesses.

Yet a further embodiment provides that the index section is formed by the ring-shaped main body and is formed as a flat ring in which a number of recesses is formed.

As described above, it should be noted that the arrangement of a pin and a recess is reciprocally exchangeable at the discrete subdivision point(s). The term “pin” is also to be interpreted broadly here. Any projecting geometric shape which is able to engage or latch into a matching recess is encompassed by the term “pin”, herein.

A further aspect of the invention provides that the main body is formed in one piece with the anti-rotation lock element(s) and, if present, with the index section(s) and the latching element(s), and is preferably formed by plastic injection molding or from a worked part made of sheet metal. This provides for a particularly simple and cost-effective construction with at the same time sufficient and durable stability. In this case, a respective fixation may also be released subsequently, if appropriate, in a non-destructive manner or—at low costs—in a destructive manner, which once again considerably increases the flexibility.

Aspects of the invention also relate to a socket device for a quick connector, wherein the socket device is configured to receive a coupling and is attached to a base component of a device for dispensing or receiving liquid or gaseous media in a motor vehicle; comprising
a connecting piece attached to the base component; and
the anti-rotation lock according to one of the above aspects or embodiments, wherein the anti-rotation lock is mounted on the connecting piece after the completion of the device manufacturing process, the device having the connecting piece attached thereto.

A further aspect relates to a corresponding quick connector which comprises
the socket device with the anti-rotation lock according to one of the above aspects or embodiments; and
a coupling with a recess matching the anti-rotation lock element of the anti-rotation lock.

The quick coupling may preferably be designed as a VDA coupling or the quick connector may be designed as a VDA quick connector, so that it can be used in accordance with standards for many vehicle components such as, for instance, electric or combustion-based heating devices, coolers or charge air ducts.

Furthermore, a method for assembling a socket device for a quick connector is also proposed, in which method the above-mentioned advantages are reflected. The method comprises the steps of:
providing a device for dispensing or receiving liquid or gaseous media in a motor vehicle with a socket attached thereto;
providing the anti-rotation lock as described above;
plugging the anti-rotation lock to the connecting piece;
latching the anti-rotation lock with the aid of a latching element formed thereon in a groove at the base of the connecting piece for axially defining the position of the anti-rotation lock on the connecting piece;
latching the anti-rotation lock with the aid of an index section formed thereon in a corresponding index section which is arranged in a surrounding area of the connecting piece on a device, in order to define the position of the anti-rotation lock in a circumferential direction.

Further advantages, features and details of the various aspects result from the claims, the following description of preferred embodiments and with reference to the drawings. In the figures, the same reference numerals denote the same features and functions.

### BRIEF DESCRIPTION OF THE DRAWINGS

In the drawings:

FIG. 1 shows a quick coupling in a perspective view;

FIG. 2 the same as in FIG. 1, but from a different perspective;

FIG. 3 the same as in FIGS. 1 and 2, but from a still different perspective;

FIG. 4 shows an overview of a connecting piece arranged on a base component with an anti-rotation lock (on the right) according to a first embodiment in a perspective view;

FIG. 5 shows the anti-rotation lock of FIG. 4 according to a second embodiment in an enlarged perspective view;

FIG. 6 shows the connecting piece arranged on the base component with an anti-rotation lock of FIG. 4 (second embodiment) in an enlarged perspective view;

FIG. 7 shows a connecting piece arranged on the base component with an anti-rotation lock according to a third embodiment in an enlarged perspective view;

FIG. 8 shows a connecting piece arranged on the base component with an anti-rotation lock according to a fourth embodiment in an enlarged perspective view;

FIG. 9 shows an overview of a connecting piece arranged on a base component with the anti-rotation lock of FIG. 8 according to the fourth embodiment in a perspective view;

FIG. 10 shows an overview of a connecting piece arranged on a base component without an anti-rotation lock as a comparative example in a perspective view;

FIG. 11 shows an anti-rotation lock according to a fifth embodiment in an enlarged perspective view;

FIG. 12 shows an overview of a connecting piece arranged on a base component with the anti-rotation lock of FIG. 11 according to the fifth embodiment in a perspective view;

FIG. 13 shows an overview of a connecting piece arranged on a base component (on the right) with an anti-rotation lock integrally shaped thereon according to a comparative example in a perspective view;

FIG. 14 shows the connecting piece of FIG. 13 with an anti-rotation lock integrally shaped therewith according to the comparative example in a highlighted illustration in a perspective view.

### PREFERRED EMBODIMENT(S) OF THE INVENTION

In the following description of preferred embodiments, it is to be taken into consideration that the present disclosure of the various aspects is not restricted to the details of the construction and the arrangement of the components as illustrated in the following description and in the figures. The embodiments may be implemented or put into practice in various ways. It is furthermore to be taken into consideration that the phraseology and terminology used here is used only for the purpose of the specific description and should not be interpreted by a person skilled in the art as such in a restrictive manner. Furthermore, in the following description, the same reference numerals in the various embodiments or figures denote the same or similar features or objects, so that in some cases a repeated detailed description thereof is dispensed with in order to preserve the compactness and clarity of the illustration.

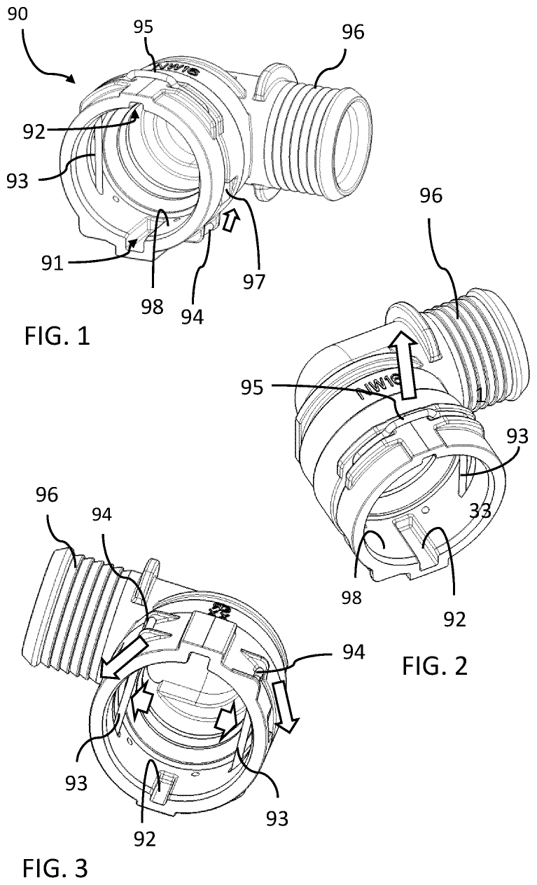

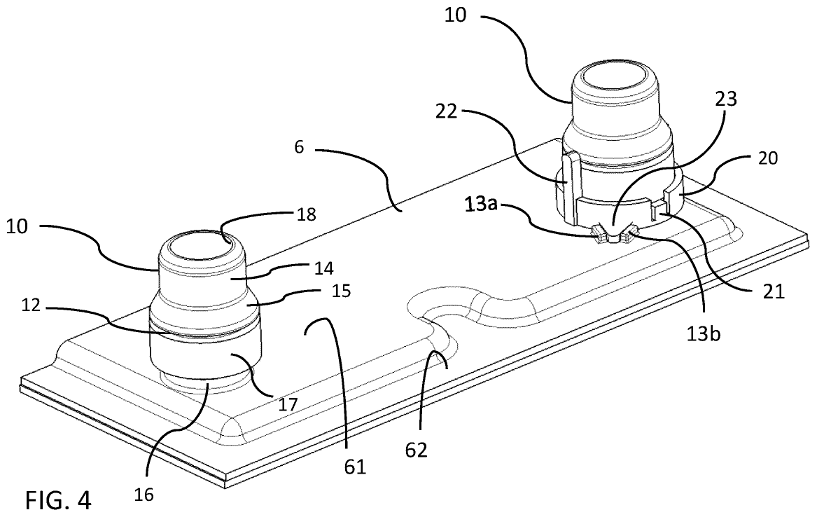

Firstly, for a better understanding of the invention, FIGS. 1-3 show an overview of a quick coupling 90 known per se, as is applicable with respect to a connecting piece with anti-rotation locks according to embodiments. Furthermore, the combination of the quick coupling shown in FIGS. 1-3 with the anti-rotation locks shown in FIGS. 4-9 and 11-12 and the associated connecting piece including any index sections on the base component forms a quick connector according to embodiments of the invention. The embodiments shown here each relate to VDA quick connectors. Other embodiments not shown herein relate to other types or differently standardized quick connectors (e.g. Henn, etc.), but include similar basic principle as shown in the figures.

The quick coupling 90 is designed as an angle connector and comprises an end section 96, onto which a flexible hose (not shown), for example, can be drawn in a sealing manner. An opposite end section of the quick coupling 90 comprises the actual coupling mechanism. The opposite end section is formed by an opening 98, in the inner surface of which two anti-rotation locks 91, 92 which are opposite one another and are formed as grooves are arranged. These grooves extend parallel and longitudinally to a central axis of the quick coupling 90, which central axis pertains to that opening 98.

In FIG. 4, on the left-hand side, a connecting piece 10 (without anti-rotation lock) can be seen, onto which the quick coupling 90 shown in FIGS. 1-3 can be coupled. The connecting piece 10 has a substantially tubular structure with a distal opening 18 and an adjoining first cylindrical section 14 having a smaller diameter, an adjoining tapering section 15, an adjoining second cylindrical section 17 having a larger diameter, a recess 12 which extends in a ring-shaped manner about a central axis of the connecting piece 10 in the second cylindrical section 17, close to the tapering section 15, and a groove section 16 which forms the base of the connecting piece 10 on a first base surface 61 of a device 6 and similarly extends in a ring-shaped manner about the central axis of the connecting piece 10, which groove section 16 adjoins the second cylindrical section 17 as seen from the opening 18. The groove section 16 may be of cylindrical design. The central axis of the connecting piece 10 is perpendicular to the first base surface 61 of a base component 63. Without restricting the generality, the base component 63 may be a heat exchanger of an electric heater (as device 6).

As can be seen in FIGS. 1-3, the quick coupling 90 has, as a coupling mechanism, a clamp, preferably made of metal, which is formed by a tension section 95, two spring arms 93 extending in a fork-like manner symmetrically from the tension section 95, and two lugs 94 provided correspondingly at the ends of the spring arms 93, which lugs are formed by bending the ends by, for example, 90°. The two spring arms 93 are provided being biased inwards. The tension section 95 is located on the outside of the quick coupling 90, wherein the two spring arms 93 each extend through an edge region of the interior space of the opening 98 via cutouts in the tubular body of the quick coupling 90 and thereby narrow the opening 98. The lugs 94 at the ends of the spring arms 93 each extend through opposite cutouts in the tubular body of the quick coupling 90 and, under mechanical stress, also rest with the bent-over end on the outer surface of the quick coupling 90.

When the coupling 90 is coupled to the connecting piece 10, the spring arms 93 extending through the interior space of the opening 98, after unhindered passage of the first cylindrical section 14 having the small diameter, meet the tapering section 15, which gradually pushes the two spring arms 93 apart counter to their clamping force, until they reach the second cylindrical section 18 under now increased mechanical stress and latch into the circumferential recess 12. In this state, the first cylindrical section 14 has already penetrated deeply into the quick coupling 90 and is, for example, in contact with an O-ring, which is held in the interior of the opening 98 by a retaining ring (both not shown in the figures for the sake of simplicity), so that a sealing connection is now produced between a hose, which is configured to guide a medium, and the device.

In order to release the connection, the tension section 95 of the quick coupling 90 may, for example, be pulled away from the surface of the quick coupling 90 with the aid of a tool, so that the opposite lugs 94 at the ends of the spring arms 93 are operated to effect a spreading of the spring arms 93 in a sliding manner on the outer surface and in a manner guided by an elongate cutout in the surface, wherein the latter opens up the interior space of the opening 98, as can be seen by the arrows in FIG. 3. As a result, the spring arms 93 also leave the circumferential recess 12 on the connecting piece 10, so that the quick coupling 90 can be pulled off.

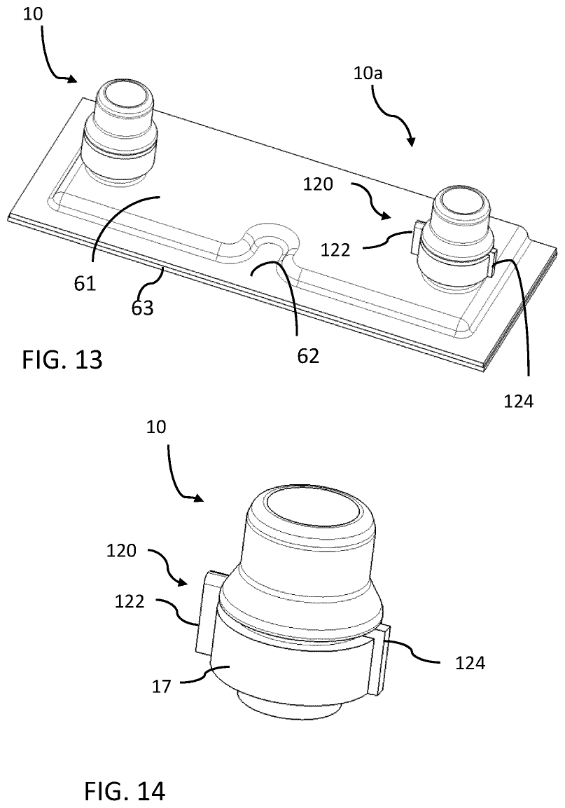

For comparison, the same quick coupling 90 may also cooperate with a connecting piece 10a as shown in FIGS. 13 and 14 (on the right-hand side) to thereby form a quick connector. FIGS. 13 and 14 show a comparative example of a connecting piece 10a with an anti-rotation lock 120 which is formed or shaped integrally fixedly therewith. The connecting piece 10a and the anti-rotation lock 120 are formed in one piece (for example uniform injection molding or adhesive bonding/welding). Matching the anti-rotation locks 91, 92 formed as cutouts on the side of the quick coupling 90, the anti-rotation lock 120 comprises, on the side of the connecting piece 10a, two anti-rotation lock elements 122, 124 which are formed opposite one another on a cylindrical section 17 of the connecting piece. The quick coupling 90 is plugged onto the connecting piece 10a such that the anti-rotation lock elements 122, 124 are placed in the cutouts of the anti-rotation locks 91, 92, so that a rotation of the quick coupling 90 about the axis of the connecting piece 10a or about its own axis is no longer possible.

However, the described function of the quick coupling 90 with respect to a quick connector also extends to the embodiments shown in FIGS. 4-12.

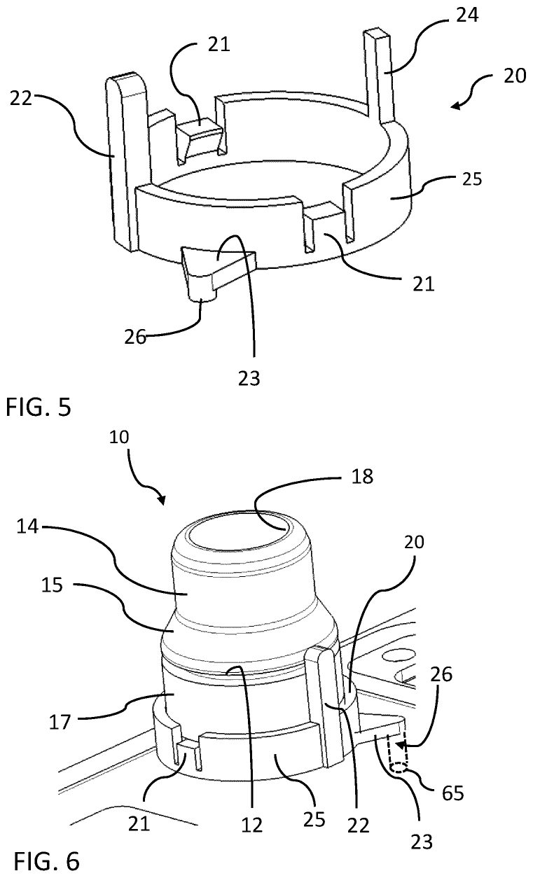

FIG. 4 shows a first embodiment and FIGS. 5 and 6 show a similar second embodiment of an anti-rotation lock 20 which can be applied (and possibly also optionally removed again) as a separate part, for example onto the above-described connecting piece 10. Both variants or embodiments are described together below.

As FIG. 5 shows in greater detail, the anti-rotation lock 20 has a substantially ring-shaped construction with a main body 25 which has a cylindrical shape. Cutouts are made in the main body 25 on two opposite sides, in each of which cutouts a latching element 21 extends in the axial direction from the main body 25 upward (in the state mounted on the connecting piece, as shown in FIGS. 4 and 6, in the direction of the opening 18 thereof and away from the first surface 61 of the base component 63 which surrounds the connecting piece 10). In accordance with a thickness of the cylinder jacket of the main body 25, the depth of the cutout, and the material used (for example plastic injection molding or a sheet metal formed part), the latching element 21 can be bent outward in a radial direction. This is in particular because the latching element 21 in the embodiment has a section which protrudes radially inwards and in this case is specifically tapered, which reduces the inner diameter of the main body 25. As can be seen from FIG. 6, however, the inner diameter of the main body 25 corresponds approximately to the outer diameter of the second cylindrical section 17 of the connecting piece 10.

When mounting the anti-rotation lock 20 on the connecting piece 10, the ring-shaped main body 25 is therefore pushed over the first cylindrical section 14 and the tapering section 15, in order then to slide over the second cylindrical section 17 in a more or less contacting manner, until the ring-shaped main body 25 rests on the base surface 61 of the base component 63. During this operation, the latching element 21 is pressed outward by the tapering section 15 and slides on the second cylindrical section 17, until it reaches the groove section 16 at the base of the connecting piece 10, in which groove section the latching element 21 latches in. Accordingly, the height of the latching element 21 is approximately the height of the groove section 16-or slightly less for the sake of tolerance. Consequently, the anti-rotation lock 20 is now securely and reliably placed in an axial direction of the connecting piece 10.

Again with reference to FIG. 5, a first anti-rotation lock element 22 and a second anti-rotation lock element 24 each correspondingly extend from the ring-shaped main body 25 on opposite sides in an axial direction. In order to avoid an inadvertent 180° offset coupling of the quick coupling 90 to the connecting piece 10 with regard to the anti-rotation lock 20, the length in an axial direction, the depth in a radial direction and the width in a circumferential direction between the two anti-rotation lock elements 22, 24 are selected differently. The same also applies to the corresponding grooves of the anti-rotation lock elements 91 and 92 on the side of the quick coupling 90. The anti-rotation lock element 22 is dimensioned to match the anti-rotation lock element 91, and the anti-rotation lock element 24 is dimensioned to match the anti-rotation lock element 92 on the quick coupling 90, so that an erroneous misplacement becomes impossible.

A fixing of the position of the anti-rotation lock elements 22 and 24 in a circumferential direction is established by an index section 23 which, in the first embodiment (FIG. 4), is formed as a substantially flat triangular projection which extends outward from the ring-shaped main body 25 in a radial direction.

In the variant according to FIG. 4, the index section rests flat on the flat base surface 61 (no pin as in the second variant according to FIGS. 5 and 6 described below). Rather, the index section 23 is placed here in a form-fitting manner in a triangular space between two walls 13a, 13b which are arranged obliquely with respect to one another on the base surface 61 and which represent an index section on the device side with only one subdivision point. Due to the only one projection, the index section 23 of this variant is also restricted to one subdivision point.

In the variant according to FIGS. 5 and 6, on the other hand, a pin 26 which extends downward in an axial direction (in the mounted state toward the base surface 61 of the base component 63) and which represents the single subdivision point of the index section 23 is located at the radially outer end of the projection.

As can be seen in FIG. 6, this pin 26 engages in a recess 65 in the first base surface 61 of the base component 63. The recess 65 in the first base surface 61 of the base component 63 forms an index section on the device side. The index section 23 on the side of the anti-rotation lock 20 and the index section on the device side are coordinated with one another in that the distances of the respective subdivision points from a common central axis of the connecting piece 10 correspond to each other, wherein only one subdivision point is present in each case in this specific embodiment. Because only one discrete subdivision point is present here on both sides, there is only one single selection possibility for an orientation of the anti-rotation lock 20 in a circumferential direction when the anti-rotation lock 20 is mounted on the connecting piece 10. This can be intentional in order to avoid errors.

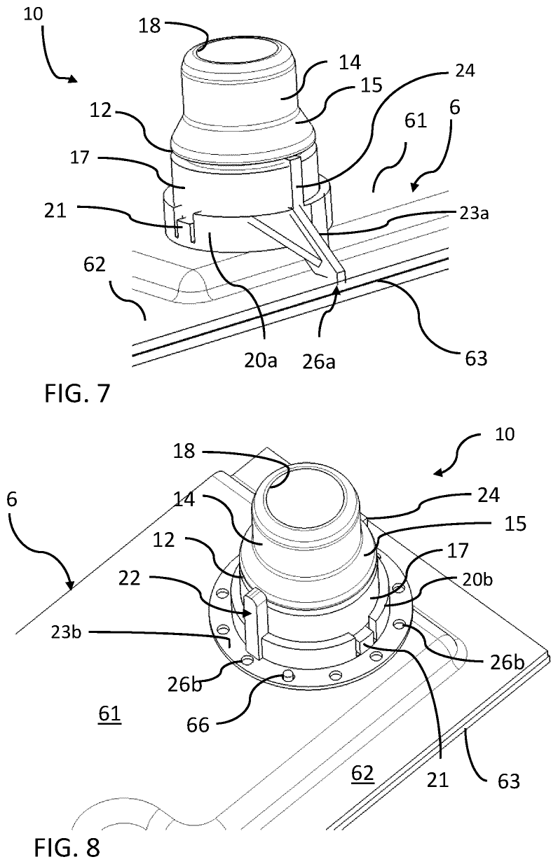

A third embodiment is shown in FIG. 7. The third embodiment differs only slightly from the first and the second embodiment. The index section 23a of the anti-rotation lock 20a is also formed here as a substantially triangular projection which extends outward from the main body 25 in a radial direction. However, it extends further in this embodiment in order to engage in a recess which is formed on a second base surface 62 which is lower than the first base surface 61. As a result of this measure, it is possible to take account of a not exclusively planar surface structure of the base component 63.

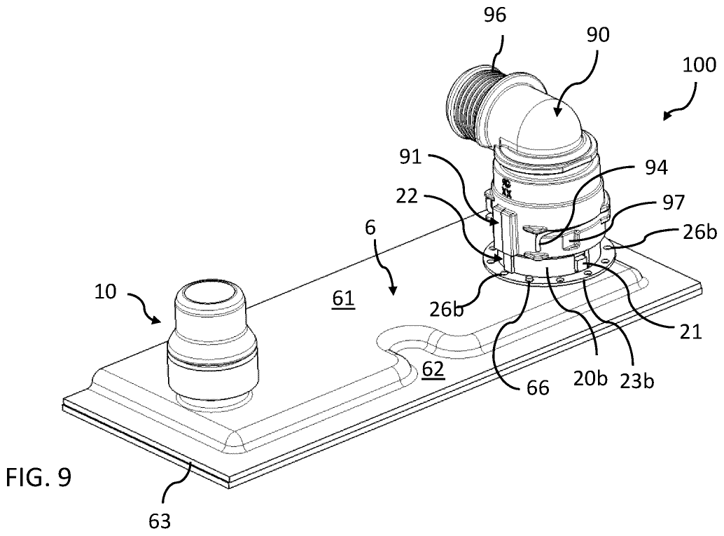

A fourth embodiment is shown in FIGS. 8-10. The corresponding anti-rotation lock 20b is shown here only in FIGS. 8 and 9. In contrast to the above embodiments, the index section 23b herein includes a larger number of subdivision points which extend at a common distance from the central axis of the connecting piece 10 at equidistant intervals with respect to each other. In the present case, there are 12 subdivision points. The index section 23b may also be considered herein as a projection which protrudes radially from the ring-shaped main body 25, but which extends circumferentially. The subdivision points are implemented herein as recesses 26b, in particular as holes. A pin 66 which stands upright on the first base surface 61 of the base component 63 of the device 6 may engage in each one of these recesses, in order to define the orientation of the anti-rotation lock 20b in a circumferential direction. This embodiment enables a selective orientation of the anti-rotation lock 20b from a number of positions which are possible herein, for example, 12.

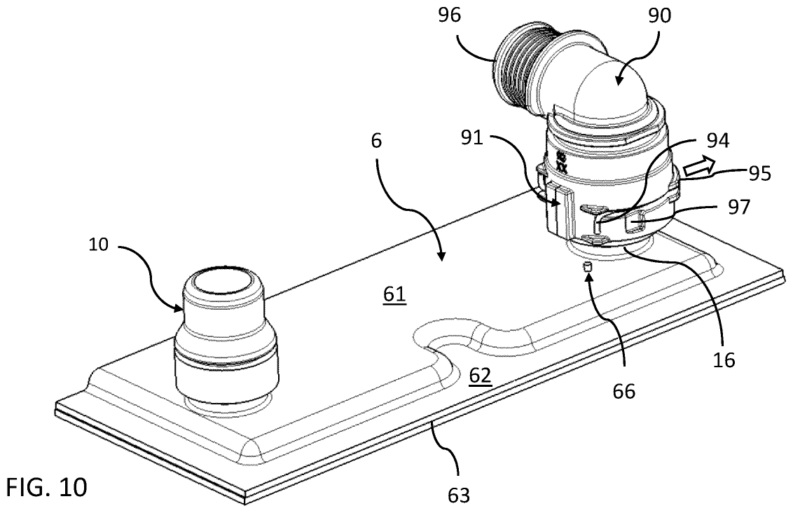

FIG. 9 shows the assembled and coupled quick connector 100 with the anti-rotation lock 20b according to the fourth embodiment. In comparison, FIG. 10 shows the case in which the anti-rotation lock 20b has simply been omitted (i.e. not mounted), for example in order to enable a further free rotatability of the connector with respect to the device 6 (the base component 63 is the same as in FIG. 9, i.e. with pin 66). This option conventionally did not exist with an anti-rotation lock integrally formed on or shaped in the connecting piece.

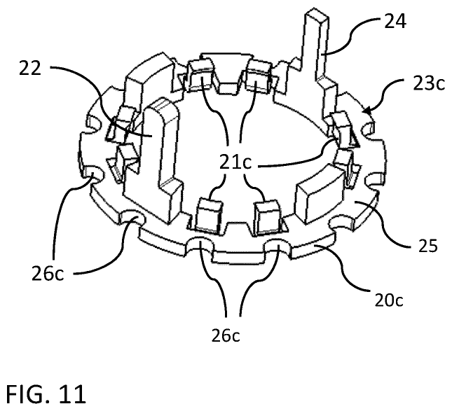

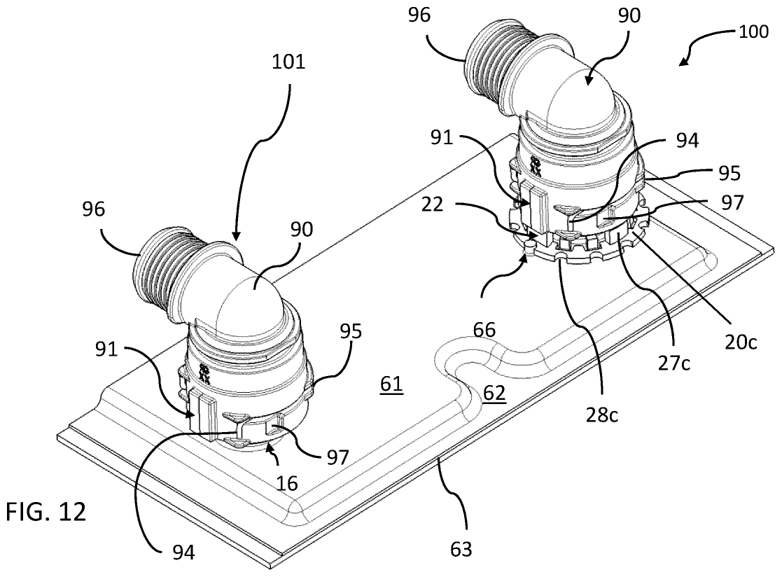

A fifth embodiment is shown in FIGS. 11 and 12. The embodiment is similar to the fourth embodiment, but differs from the latter, inter alia, in that the index section 23c with the recesses 26c for the pin 66 forms a flat, disk-shaped ring in such a way that the latter at the same time constitutes the main body 25 as a whole, i.e., a cylindrical shell-shaped construction of the main body is omitted. The latching elements 21c extend inward from the flat ring of the index section 23c into correspondingly formed incisions on the inner edge. The mode of operation is similar to that described above in the case of the latching element 21 of the first four embodiments.

The recesses 26c are formed herein not as holes but as semicircular cutouts in the outer edge region of the flat ring of the index section 23c. As to the rest, the arrangement of the recesses 26c is analogous to the recesses 26b of the fourth embodiment. Compared to the corresponding quick connector 100 (on the right side in FIG. 12) according to the embodiment, FIG. 12 shows a quick connector 101 without an anti-rotation lock as a comparative example on the left-hand side, wherein, however, the pin (not visible in perspective) can be provided on the base surface as an element which is not used there (this does not apply, however, to the corresponding connecting piece 10 in FIGS. 4, 9 and 10, where no pin 66, no recess 65, no pair of walls 13a, 13b, or the like is formed each on the left side, respectively).

In all the embodiments shown, the anti-rotation lock is advantageously formed in one piece and as a closed ring. However, a plurality of parts is not excluded in principle.

### List of Reference Numerals

6 Device (heater, cooler, etc.)
10 connecting piece
12 recess
13a, 13b pair of walls
14 first cylindrical section
15 tapering section
16 groove section
17 second cylindrical section
18 opening (connecting piece)
20, 20a, 20b, 20c anti-rotation lock
21, 21c latching element
22,24 anti-rotation lock elements
23, 23a, 23b, 23c index section
25 ring-shaped main body
26 pin
26b, 26c recess
61 first base surface
62 second base surface
63 base component
65 recess
66 pin
100 quick connector (embodiment)
101 quick connector (comparative example)

1. : An anti-rotation lock, for a connecting piece of a quick connector which is configured to receive a coupling; comprising:
a main body having at least one first anti-rotation lock element which is configured and dimensioned to form a projection on the connecting piece, the projection extending in an axial direction with respect to the connecting piece and being configured to interact with a matching recess in the coupling, in order to prevent a rotation of the coupling relative to the connecting piece in a coupled state of the quick connector;
wherein the main body having the at least one first anti-rotation lock element is formed as a component which is separate from the connecting piece.

2. The anti-rotation lock according to claim 1, wherein
the main body has a ring shape with a central axis,
which coincides with a central axis of the anti-rotation lock in a state of the anti-rotation lock assembled with the connecting piece.

3. The anti-rotation lock according to claim 2, comprising
the first anti-rotation lock element and a second anti-rotation lock element which are located opposite each other at the ring-shaped main body and extend from the main body in a direction parallel to the central axis,
wherein the two anti-rotation lock elements have at least one of: a mutually different length in an axial direction, a mutually different width in a circumferential direction, and a mutually different depth in a radial direction, in order to exclude an alternative coupling possibility that is rotated by 180° in cooperation with correspondingly dimensioned matching recesses in the coupling.

4. The anti-rotation lock according to claim 2, further comprising:
at least one latching element which is attached to the ring-shaped main body and is configured to engage in a groove at a base of the connecting piece, in order to fix the anti-rotation lock in a defined position in an axial direction.

5. The anti-rotation lock according to claim 2, further comprising
an index section which is configured to cooperate in a form-fitting manner with a corresponding index section which is arranged in a surrounding area of the connecting piece on a device, in order to be able to fix the anti-rotation lock in at least one defined position in a circumferential direction.

6. The anti-rotation lock according to claim 5, wherein
at least one of: the index section of the anti-rotation lock and the index section on the device have a plurality of defined subdivision points in a circumferential direction.

7. The anti-rotation lock according to claim 5, wherein
the index section is formed by a projection which extends outward from the ring-shaped main body in a radial direction and by a pin which extends from the projection in a substantially axial direction and is configured to latch into a recess in a surrounding area of the connecting piece on the device.

8. The anti-rotation lock according to claim 5, wherein
the index section is formed by a projection, which extends outward from the ring-shaped main body in a radial direction and is formed as a flat ring, and by a number of recesses.

9. The anti-rotation lock according to claim 5, wherein
the index section is formed by the ring-shaped main body and is formed as a flat ring in which a number of recesses is formed.

10. The anti-rotation lock according to claim 2, wherein
the ring-shaped main body is formed in one piece with the anti-rotation lock element(s) and, if present, with the index section(s) and the latching element(s), and is at least one of: formed by plastic injection molding and from a worked part made of sheet metal.

11. A socket device for a quick connector, wherein the socket device is configured to receive a coupling and is attached to a device for dispensing or receiving liquid or gaseous media in a motor vehicle; comprising
a connecting piece attached to the device; and
an anti-rotation lock, wherein the anti-rotation lock is mounted on the connecting piece after the completion of the device having the connecting piece attached thereto, wherein the anti-rotation lock comprises: a main body having at least one first anti-rotation lock element which is configured and dimensioned to form a projection on the connecting piece, the projection extending in an axial direction with respect to the connecting piece and being configured to interact with a matching recess in the coupling, in order to prevent a rotation of the coupling relative to the connecting piece in a coupled state of the quick connector,
wherein the main body having the at least one first anti-rotation lock element is formed as a component which is separate from the connecting piece; and
wherein the main body has a ring shape with a central axis, which coincides with a central axis of the anti-rotation lock in a state of the anti-rotation lock assembled with the connecting piece.

12. The socket device of claim 11, wherein the quick connector comprises:
a coupling with a recess matching the anti-rotation lock element of the anti-rotation lock.

13. A method for assembling a socket device for a quick connector, comprising:
providing a device for dispensing or receiving liquid or gaseous media in a motor vehicle with a connecting piece attached thereto;
providing an anti-rotation lock,
attaching the anti-rotation lock to the connecting piece;
latching the anti-rotation lock with the aid of a latching element formed thereon in a groove at the base of the connecting piece for axially defining the position of the anti-rotation lock on the connecting piece;
latching the anti-rotation lock with the aid of an index section formed thereon in a corresponding index section which is arranged in a surrounding area of the connecting piece on a device, in order to define the position of the anti-rotation lock in a circumferential direction.
